(19) United States
(12) Patent Application Publication
(10) Pub. No.: US 2013/0088617 A1
(43) Pub. Date: Apr. 11, 2013

(54) APPARATUS AND METHOD FOR STORING SNAPSHOT IMAGE

(71) Applicant: ELECTRONICS AND TELECOMMUNICATIONS R, Daejeon (KR)

(72) Inventors: Dong-Wook Kang, Daejeon (KR); Chae-Deok Lim, Daejeon (KR)

(73) Assignee: ELECTRONICS AND TELECOMMUNICATIONS RESEARCH INSTITUTE, Daejeon (KR)

(21) Appl. No.: 13/647,953

(22) Filed: Oct. 9, 2012

(30) Foreign Application Priority Data
Oct. 10, 2011 (KR) 10-2011-0102940

(51) Int. Cl. H04N 5/76

(52) U.S. Cl. 348/231.99; 348/E05.031

(57) ABSTRACT

Disclosed is a technology for storing snapshot images capable of maximizing the reading performance of an SD/MMC card at the time of recovering the snapshot images and minimizing the booting time of a system. A method for storing snapshot images includes: preparing the snapshot images, attempting to allocate continuous reference blocks, in which a number of blocks corresponding to the predetermined number of reference blocks is continuous in a non-volatile memory unit, storing the snapshot images in the allocated continuous reference blocks when the allocation of the continuous reference blocks succeeds, and preparing the snapshot image storage information as a swap table and storing the prepared swap table in the non-volatile memory unit.

### CROSS-REFERENCE TO RELATED APPLICATION

This application claims priority to Korean Patent Application No. 10-2011-0102940, filed on Oct. 10, 2011, which is incorporated herein by reference in its entirety.

### BACKGROUND OF THE INVENTION

1. Field of the Invention

Exemplary embodiments of the present invention relate to an apparatus and a method for storing snapshot images, and more particularly, to an apparatus and a method for storing snapshot images capable of maximizing the reading performance of an SD/MMC card at the time of recovering snapshot images and minimizing the booting time of a system in a method for booting a snapshot.

2. Description of Related Art

Personal devices, such as a smart phone, a digital camera, a tablet PC, or the like, have proliferated widely. Therefore, the booting rate of such devices is spotlighted as an important factor in evaluating the competitiveness of a product. In order to realize a rapid booting rate, snapshot images have been used. Such snapshot images include status information about a computer system at a predetermined time, and are used to recover the existing status at the time of operation of the system. In addition, snapshot images are used to prevent consumption of standby power.

Recently, in embedded systems, interest in snapshot booting technology has increased due to the increase in the use of popular platforms such as Android. Further, a need exists for the development of a method for rapidly recovering snapshot images.

### SUMMARY OF THE INVENTION

An embodiment of the present invention is directed to minimizing the booting time of a system in a method for booting a snapshot by storing snapshot images in continuous blocks of non-volatile memory.

In addition, the present invention has been made in an effort to maximize the reading performance of snapshot images stored in non-volatile memory, that is, an SD card or an MMC card, at the time of recovering snapshot images.

In accordance with an embodiment of the present invention, a method for storing snapshot images includes: preparing the snapshot images; attempting to allocate continuous reference blocks in which blocks corresponding to the predetermined number of reference blocks are continuous in a non-volatile memory unit, storing the snapshot images in the allocated continuous reference blocks when the allocation of the continuous reference blocks succeeds, and preparing the snapshot image storage information as a swap table and storing the prepared swap table in the non-volatile memory unit.

The attempting to allocate the continuous reference blocks may further include dividing and storing the snapshot images in a plurality of varying continuous blocks by allocating the plurality of varying continuous blocks in which a number of blocks less than the number of reference blocks are continuous, when the allocation of the continuous reference blocks fails.

The non-volatile memory unit may be a secure digital (SD) or a multi media card (MMC).

The snapshot images may be formed to include at least one of status information regarding a processor, a memory, and peripheral devices of a system.

The number of reference blocks may be determined in consideration of reading performance and availability of the non-volatile memory unit and capacity of the snapshot images.

The method for storing snapshot images may further include: storing storage completion information of the snapshot images in the swap table after the storing of the snapshot images is completed.

The snapshot image storage information may include storage position information of the snapshot images and the number of blocks in which the snapshot images are stored in the non-volatile memory unit.

The method for storing snapshot images may further include: acquiring the snapshot image storage information from the swap table stored in the non-volatile memory unit, reading the blocks of the non-volatile memory unit in which the snapshot images are stored, based on the snapshot image storage information, and recovering the snapshot images stored in the non-volatile memory unit.

In accordance with another embodiment of the present invention, an apparatus for storing snapshot images includes: a preparing unit that prepares the snapshot images, a block allocation unit that allocates continuous reference blocks in which blocks corresponding to the predetermined number of reference blocks are continuous in a non-volatile memory unit, a storage unit that stores the snapshot images in the allocated continuous reference blocks when the block allocation unit successfully allocates the continuous reference blocks, and a swap table-preparing unit that prepares the snapshot image storage information as a swap table and stores the prepared swap table in the non-volatile memory unit.

The block allocation unit may allocate a plurality of varying continuous blocks in which a number of blocks less than the number of reference blocks is continuous in the non-volatile memory unit when the allocation of the continuous reference blocks fails, and the storage unit may divide and store the snapshot images in the plurality of varying continuous blocks.

The non-volatile memory unit may be a secure digital (SD) or a multi media card (MMC).

The snapshot images may be formed to include at least one of status information regarding a processor, a memory, and peripheral devices of a system.

The number of reference blocks may be determined in consideration of reading performance and availability of the non-volatile memory unit and capacity of the snapshot images.

The swap table-preparing unit may store storage completion information of the snapshot images in the swap table after the storing of the snapshot images by the storage unit is completed.

The snapshot image storage information may include the storage position information of the snapshot image and the information of the number of blocks in the non-volatile memory unit.

The apparatus for storing snapshot images may further include: a storage information acquisition unit that acquires the snapshot image storage information from the swap table stored in the non-volatile memory unit, a block read unit that reads blocks of the non-volatile memory unit in which the snapshot images are stored, based on the snapshot image storage information, and a recovery unit that recovers the snapshot images stored in the non-volatile memory unit.

### BRIEF DESCRIPTION OF THE DRAWINGS

FIG. 1 is a flow chart for describing a method for storing snapshot images in accordance with an embodiment of the present invention;

FIG. 2 is a flow chart for describing a method for recovering snapshot images stored by the method for storing snapshot images in accordance with the embodiment of the present invention; and

FIG. 3 is a block diagram illustrating a configuration of an apparatus for storing snapshot images in accordance with another embodiment of the present invention.

### DESCRIPTION OF SPECIFIC EMBODIMENTS

Exemplary embodiments of the present invention will be described below in greater detail with reference to the accompanying drawings. The present invention may, however, be embodied in different forms, and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, a method for storing snapshot images and a method for recovering the stored snapshot images in accordance with exemplary embodiments of the present invention will be described.

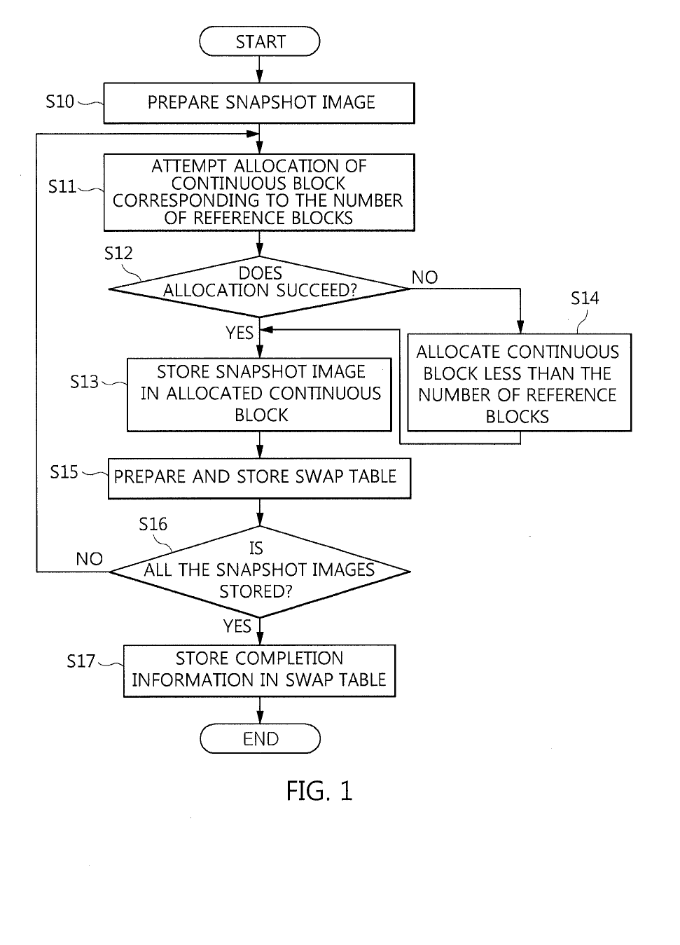

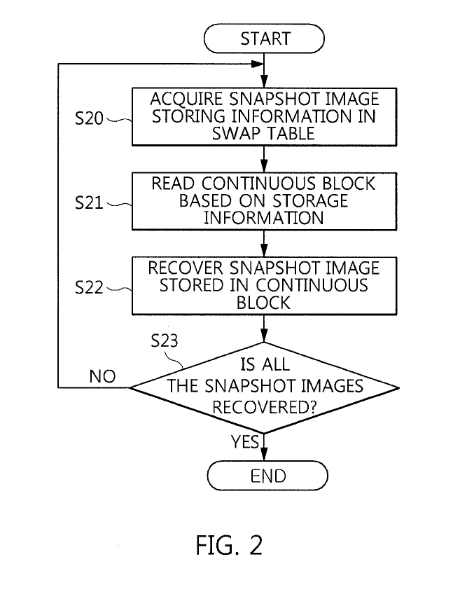

FIG. 1 is a flow chart for describing a method for storing snapshot images in accordance with an embodiment of the present invention. FIG. 2 is a flow chart for describing a method for recovering snapshot images stored using the method for storing snapshot images in accordance with the embodiment of the present invention.

Referring to FIG. 1, in a method for storing snapshot images in accordance with an embodiment of the present invention, snapshot images of a computer system are first prepared in a main memory unit (S10). In this case, the snapshot images are formed to include at least one of status information regarding a processor, memory, and peripheral system devices.

Further, an attempt is made to allocate continuous reference blocks, in which a number of blocks corresponding to the predetermined number of reference blocks in the non-volatile memory unit is continuous (S11). In detail, a continuous reference block is a section in which a number of recordable blocks corresponding to the number of reference blocks are continuous. The non-volatile memory unit is a secure digital (SD) card or a multi media card (MMC). As such, the SD card or the MMC card can be easily expanded while having a small size, has been widely used as storage for embedded systems, and is appropriately used as a snapshot image storage space because it exhibits rapid reading performance. The number of reference blocks is determined in consideration of the reading performance and availability of the non-volatile memory unit and the capacity of the snapshot images.

Further, whether the continuous reference blocks may be allocated in the non-volatile memory unit (S12) is determined.

When the allocation of the continuous reference blocks succeeds at S11 and S12, the snapshot images are stored in the allocated continuous reference blocks (S13).

When the allocation of the continuous reference blocks fails at S11 and S12, that is, when a number of continuous blocks exceeding the number of reference blocks is not present in the corresponding non-volatile memory unit, a plurality of varying continuous blocks that is less in number than the number of reference blocks is allocated (S14). In detail, the varying continuous block is a section in which the continuous number of recordable blocks corresponds to the number of reference blocks. Further, the snapshot images are divided and stored in the plurality of varying continuous blocks (S13).

That is, at S13, the snapshot images are stored in the continuous reference blocks or the varying continuous blocks. As such, in the method for storing snapshot images in accordance with the embodiment of the present invention, the snapshot images are stored in the non-volatile memory unit, that is, the continuous blocks of the SD card or the MMC card, thereby maximizing the reading performance at the time of recovering the stored snapshot images in the future.

Further, the snapshot image storage information is prepared as a swap table, and the corresponding swap table is stored in the non-volatile memory unit (S15). In this case, the swap table is prepared for the storage position information of the snapshot images and the information of the number of continuous blocks in which the snapshot images are stored, as the snapshot image storage information.

Further, whether all the snap shot images prepared at S10 are stored in the non-volatile memory unit (S16) is determined.

As the determination result at S16, when not all of the snapshot images have been stored, the allocation of continuous blocks in the non-volatile memory unit is again attempted by returning to S11.

As the determination result at S16, when all the snapshot images are stored, storage completion information regarding the non-volatile memory unit of the snapshot images is stored in the swap table (S17).

Referring to FIG. 2, in the method for recovering the stored snapshot images in accordance with the embodiment of the present invention, the snapshot image storage information stored in the non-volatile memory unit is first acquired from the swap table of the non-volatile memory unit according to the method for storing snapshot images of FIG. 1 (S20).

The continuous blocks of the non-volatile memory unit, in which the snapshot images are stored, are read based on the snapshot image storage information of the swap table (S21). In this case, the continuous blocks may be the continuous reference blocks or the varying continuous blocks.

The snapshot images stored in the non-volatile memory unit are recovered based on the read block (S22).

Further, it is determined whether all the snapshot images stored in the non-volatile memory unit have been recovered (S23). At S23, whether the recovery of the snapshot images is completed may be determined based on the storage completion information of the snapshot images stored in the swap table.

Most of the time consumed by the snapshot booting corresponds to the time taken to read the snapshot images from the storage device. The method for storing snapshot images in accordance with the embodiment of the present invention improves the reading performance by storing the snapshot images in the continuous blocks of the non-volatile memory unit, that is, the continuous reference blocks or the varying continuous blocks, such that the snapshot booting time can be effectively shortened.

The difference in the reading performance when the continuous blocks and the non-continuous blocks are read in the non-volatile memory unit can be appreciated from Table 1.

TABLE 1

| | Random Read | Random Read | Sequential Read |
|---|---|---|---|
| | (4 KB) | (512 KB) | (512 KB) |
| Sandisk 8 GB | 3.662 MB/s | 19.636 MB/s | 20.042 MB/s |
| Ultrall SD (class 4) | | | |
| Transcend SD 8 GB | 2.942 MB/s | 17.142 MB/s | 17.772 MB/s |
| (class 10) | | | |

An experiment for Sandisk 8 GB UltraII SD (class 4) and Transcend SD 8 GB (class 10) is performed. Further, it can be appreciated that the performance when a block having a size of 4 kB, corresponding to a single block in a Linux kernel, is read from a SD card and the performance when 128 continuous blocks, corresponding to 512 kB, are read differ by a factor of about five. That is, when information written in continuous blocks is read, it can be appreciated that the corresponding information is read at a rate faster than that of the case in which information recorded in non-continuous blocks is read.

Meanwhile, the method for storing snapshot images as described above may be implemented in the form of a software application comprising instructions that may be performed by various computer units, and thus may be recorded in a computer-readable recording medium. In this case, the computer readable medium may include program instructions, data files, a data structure, or the like, alone or in combinations thereof. Meanwhile, the program instructions recorded in the medium may be ones particularly designed and configured to meet the present invention, computer software, or usable ones known to those skilled in the art.

An example of the computer-readable recording medium may include magnetic media such as a hard disk, a floppy disk, and magnetic tape, optical media such as CD-ROM, DVD, magento-optical media such as a floptical disk, a hardware device particularly configured to store and perform program instructions such as ROM, RAM, flash memory, or the like. Meanwhile, the recording medium may be transmission media such as light including a carrier transmitting a signal designating program instructions, data structures, or the like, a metal line, a waveguide, or the like.

Hereinafter, the configuration and operation of an apparatus for storing snapshot images in accordance with another embodiment of the present invention will be described.

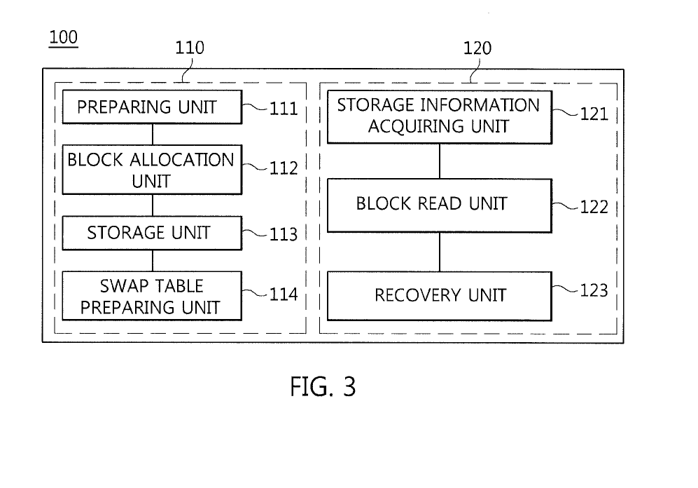

FIG. 3 is a block diagram illustrating the configuration of an apparatus for storing snapshot images in accordance with another embodiment of the present invention.

Referring to FIG. 3, an apparatus 100 for storing snapshot images in accordance with an embodiment of the present invention is configured to include a snapshot image storage unit 110 and a snapshot image recovery unit 120.

The snapshot image storage unit 110 is configured to include a preparing unit, a block allocation unit 112, a storage unit 113, and a swap table-preparing unit 114. The preparing unit 111 prepares the snapshot images in a main memory unit. In this case, the snapshot images are formed to include at least one of status information regarding a processor, a memory, and peripheral devices of a system.

The block allocation unit 112 allocates continuous reference blocks, in which a number of blocks corresponding to the predetermined number of reference blocks in the non-volatile memory unit are continuous. Further, the block allocation unit 112 allocates the plurality of varying continuous blocks comprising a number of continuous blocks less than the number of reference blocks in the non-volatile memory unit when the allocation of the continuous reference blocks fails. Here, the non-volatile memory unit is the secure digital (SD) card or the multi media card (MMC). Further, the number of reference blocks is determined in consideration of the reading performance and availability of the non-volatile memory unit and the capacity of the snapshot image.

The storage unit 113 stores the snapshot images in the allocated continuous reference blocks when the block allocation unit 112 successfully allocates the continuous reference blocks in the non-volatile memory unit. The storage unit 113 divides and stores the snapshot images in the plurality of varying continuous blocks when the block allocation unit 112 is allocated with the plurality of varying continuous blocks.

The swap table-preparing unit 114 prepares the snapshot image storage information as the swap table and stores the prepared swap table in the non-volatile memory unit. Further, the swap table-preparing unit 114 may store the storage completion information of the snapshot images in the swap table after the storing of the snapshot images is completed by the storage unit 113.

The snapshot image recovery unit 120 is configured to include a storage information acquisition unit 121, a block read unit 122, and a recovery unit 123.

The storage information acquisition unit 121 acquires the snapshot image storage information in the swap table stored in the non-volatile memory unit.

The block read unit 122 reads the blocks of the non-volatile memory unit, in which the snapshot images are stored, based on the snapshot image storage information.

The recovery unit 123 recovers the snapshot images stored in the blocks of the non-volatile memory unit read in the block read unit 122.

As described above, the method and apparatus for storing snapshot images may not be limited to the configuration and method of the above-mentioned exemplary embodiments, and therefore, all or a part of each exemplary embodiment may be configured by being selectively combined so that the exemplary embodiments of the present invention may be variously changed.

The embodiment of the present invention can minimize the booting time of the system in the method for booting a snapshot by storing the snapshot images in the continuous blocks of the non-volatile memory.

In addition, the present invention can maximize the reading performance of the snapshot images stored in the non-volatile memory, that is, the SD card or the MMC card, at the time of recovering the snapshot images.

While the present invention has been described with respect to the specific embodiments, it will be apparent to those skilled in the art that various changes and modifications may be made without departing from the spirit and scope of the invention as defined in the following claims.

What is claimed is:

1. A method for storing snapshot images, comprising:
preparing the snapshot images;
attempting allocation of continuous reference blocks in which a number of blocks corresponding to a predetermined number of reference blocks is continuous in a non-volatile memory unit;
storing the snapshot images in the allocated continuous reference blocks when the allocation of the continuous reference blocks succeeds; and
preparing snapshot image storage information as a swap table and storing the prepared swap table in the non-volatile memory unit.

2. The method of claim 1, wherein the attempting the allocation of the continuous reference blocks further includes dividing and storing the snapshot images in a plurality of varying continuous blocks by allocating the plurality of varying continuous blocks in which a number of blocks less than the number of reference blocks is continuous, when the allocation of the continuous reference blocks fails.

3. The method of claim 1, wherein the non-volatile memory unit is a secure digital (SD) or a multi media card (MMC).

4. The method of claim 1, wherein the snapshot images are formed to include at least one of status information regarding a processor, a memory, and peripheral devices of a system.

5. The method of claim 1, wherein the number of reference blocks is determined in consideration of reading performance and availability of the non-volatile memory unit and capacity of the snapshot images.

6. The method of claim 1, further comprising: storing storage completion information of the snapshot images in the swap table after the storing of the snapshot images is completed.

7. The method of claim 1, wherein the snapshot image storage information includes storage position information of the snapshot images and a number of blocks in which the snapshot images are stored in the non-volatile memory unit.

8. The method of claim 1, further comprising:
acquiring the snapshot image storage information from the swap table stored in the non-volatile memory unit,
reading the blocks of the non-volatile memory unit in which the snapshot images are stored, based on the snapshot image storage information, and
recovering the snapshot images stored in the non-volatile memory unit.

9. An apparatus for storing snapshot images, comprising:
a preparing unit that prepares the snapshot images,
a block allocation unit that allocates continuous reference blocks in which a number of blocks corresponding to a predetermined number of reference blocks is continuous in a non-volatile memory unit,
a storage unit that stores the snapshot images in the allocated continuous reference blocks when the block allocation unit successfully allocates the continuous reference blocks, and
a swap table-preparing unit that prepares a snapshot image storage information as a swap table and stores the prepared swap table in the non-volatile memory unit.

10. The apparatus of claim 9, wherein the block allocation unit allocates a plurality of varying continuous blocks in which a number of blocks less than the number of reference blocks is continuous in the non-volatile memory unit when the allocation of the continuous reference blocks fails, and
the storage unit divides and stores the snapshot images in the plurality of varying continuous blocks.

11. The apparatus of claim 9, wherein the non-volatile memory unit is a secure digital (SD) or a multi media card (MMC).

12. The apparatus of claim 9, wherein the snapshot images are formed to include at least one of status information regarding a processor, a memory, and peripheral devices of a system.

13. The apparatus of claim 9, wherein the number of reference blocks is determined in consideration of reading performance and availability of the non-volatile memory unit and capacity of the snapshot images.

14. The apparatus of claim 9, wherein the swap table-preparing unit stores storage completion information of the snapshot images in the swap table after the storing the snapshot images by the storage unit is completed.

15. The apparatus of claim 9, wherein the snapshot image storage information includes the storage position information of the snapshot image and the information of the number of blocks in the non-volatile memory unit.

16. The apparatus of claim 9, further comprising:
a storage information acquisition unit that acquires the snapshot image storage information from the swap table stored in the non-volatile memory unit,
a block read unit that reads blocks of the non-volatile memory unit in which the snapshot images are stored, based on the snapshot image storage information, and
a recovery unit that recovers the snapshot images stored in the non-volatile memory unit.
